(19) United States
(12) Patent Application Publication
(10) Pub. No.: US 2014/0095914 A1
(43) Pub. Date: Apr. 3, 2014

(54) INFORMATION PROCESSING APPARATUS AND OPERATION CONTROL METHOD

(71) Applicant: Kabushiki Kaisha Toshiba, Tokyo (JP)

(72) Inventors: Hideaki Andou, Ome-shi (JP); Yasuyuki Mizuura, Tokyo (JP)

(21) Appl. No.: 13/942,288

(22) Filed: Jul. 15, 2013

(30) Foreign Application Priority Data
Sep. 28, 2012 (JP) 2012-218138

(51) Int. Cl. G06F 1/32

(52) U.S. Cl. CPC G06F 1/3265
USPC 713/323

(57) ABSTRACT

According to one embodiment, an information processing apparatus includes a display processor and a power-saving setup module. The display processor displays on a screen a first interface including a slider which is movable along a path. The power-saving setup module sets values of a plurality of power-saving setup items in accordance with a position of the slider on the path, such that the information processing apparatus operates in a power-saving mode of one of a plurality of power-saving levels. The display processor changes, if a value of at least one power-saving item of the plurality of power-saving setup items is changed by a second interface which is different from the first interface, the position of the slider on the path.

### CROSS-REFERENCE TO RELATED APPLICATIONS

This application is based upon and claims the benefit of priority from Japanese Patent Application No. 2012-218138, filed Sep. 28, 2012, the entire contents of which are incorporated herein by reference.

### FIELD

Embodiments described herein relate generally to a technique for power saving.

### BACKGROUND

In recent years, various information processing apparatuses, such as a personal computer (PC) and a tablet, have been developed. Most of such information processing apparatuses have a power-saving function. The power-saving function is a function for setting up an operational environment which affects the amount of power that is consumed by the system, and, in some cases, the power-saving function is called “power management function”. By executing power-saving setup for some power-saving setup items in the PC, the user can reduce the power consumption of the PC.

Recently, attention has been paid to the power-saving function of the PC, from the standpoint of energy saving. If the power-saving functions of PCs in homes and PCs in companies are properly utilized, it is possible that a great deal of power can be saved, with a contribution to power-saving (ecology).

However, the operation of setting up the power-saving function of the PC is not always easy for the user. Thus, there is a case in which the power-saving effect, which is intended by the user, cannot sufficiently be obtained by the power-saving setup by the user. Therefore, it is necessary to realize a novel function for easily setting up the power-saving function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 is an exemplary block diagram illustrating the system configuration of the information processing apparatus of the embodiment.

FIG. 3 is an exemplary view for explaining a power-saving setup screen which is displayed by a power-saving utility program of the information processing apparatus of the embodiment.

FIG. 4 is an exemplary view illustrating the relationship between power-saving levels and respective power-saving setup values, which are managed by the power-saving utility program of the information processing apparatus of the embodiment.

FIG. 5 is an exemplary view illustrating the relationship between slider levels and respective power-saving setup values, which are managed by the power-saving utility program of the information processing apparatus of the embodiment.

FIG. 6 is a view illustrating an example of a power-saving setup screen for individually changing power-saving setup values of respective power-saving setup items.

FIG. 7 is a view for explaining intervals of movement of a slider which is displayed on the power-saving setup screen of FIG. 3.

FIG. 8 is an exemplary view illustrating a state in which the setup value of a certain power-saving setup item is changed on the power-saving setup screen of FIG. 6.

FIG. 9 is an exemplary view for explaining an operation of correcting (changing) the position of the slider which is displayed on the power-saving setup screen of FIG. 3.

FIG. 10 is an exemplary view illustrating a state in which the setup value of a certain power-saving setup item is changed to a value outside the range of power-saving setup on the power-saving setup screen of FIG. 6.

FIG. 11 is an exemplary view for explaining another example of the operation of correcting (changing) the position of the slider which is displayed on the power-saving setup screen of FIG. 3.

FIG. 12 is an exemplary block diagram illustrating the configuration of the power-saving utility program of the information processing apparatus of the embodiment.

FIG. 13 is an exemplary flow chart illustrating the procedure of a power-saving setup process which is executed by the information processing apparatus of the embodiment.

### DETAILED DESCRIPTION

Various embodiments will be described hereinafter with reference to the accompanying drawings.

In general, according to one embodiment, an information processing apparatus includes a display processor and a power-saving setup module. The display processor is configured to display on a screen a first interface including a slider which is movable along a path. The power-saving setup module is configured to set values of a plurality of power-saving setup items in accordance with a position of the slider on the path, such that the information processing apparatus operates in a power-saving mode of one of a plurality of power-saving levels. The display processor is further configured to change, if a value of at least one power-saving item of the plurality of power-saving setup items is changed by a second interface which is different from the first interface, the position of the slider on the path based on the changed value of the at least one power-saving setup item.

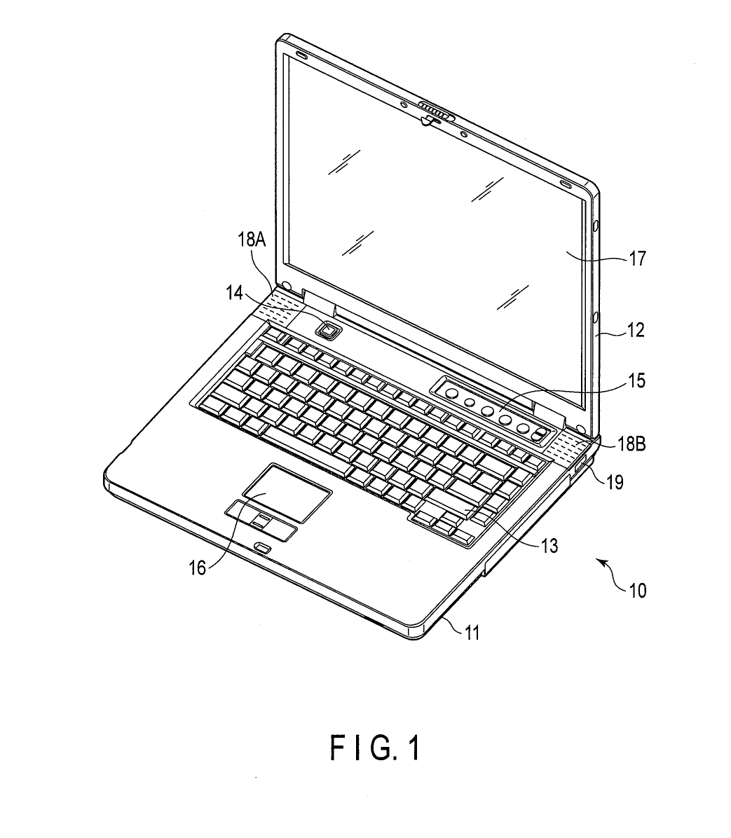

FIG. 1 is a perspective view showing the external appearance of an information processing apparatus according to an embodiment. This information processing apparatus is an electronic apparatus such as a personal computer (PC), a PDA, a tablet, a smartphone, or a TV. In the description below, the case is assumed that the information processing apparatus is realized as a notebook-type personal computer 10.

As shown in FIG. 1, the computer 10 is composed of a computer main body 11 and a display unit 12. An LCD (liquid crystal display) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered with the display unit 12.

The computer main body 11 has a thin box-shaped housing. A keyboard 13, a power button 14 for powering on/off the computer 10, an input operation panel 15, a pointing device 16 such as a touch pad, and speakers 18A and 18B are disposed on the top surface of the housing of the computer main body 11. Various operation buttons are provided on the input operation panel 15.

The right side surface of the computer main body 11 is provided with a USB (universal serial bus) connector 19. Various peripheral devices can be connected to the USB connector 19. An external display connection terminal (not shown), which supports, e.g. the HDMI (high-definition multimedia interface) standard, is provided on the rear surface of the computer main body 11. The external display connection terminal is used to output a digital video signal to an external display.

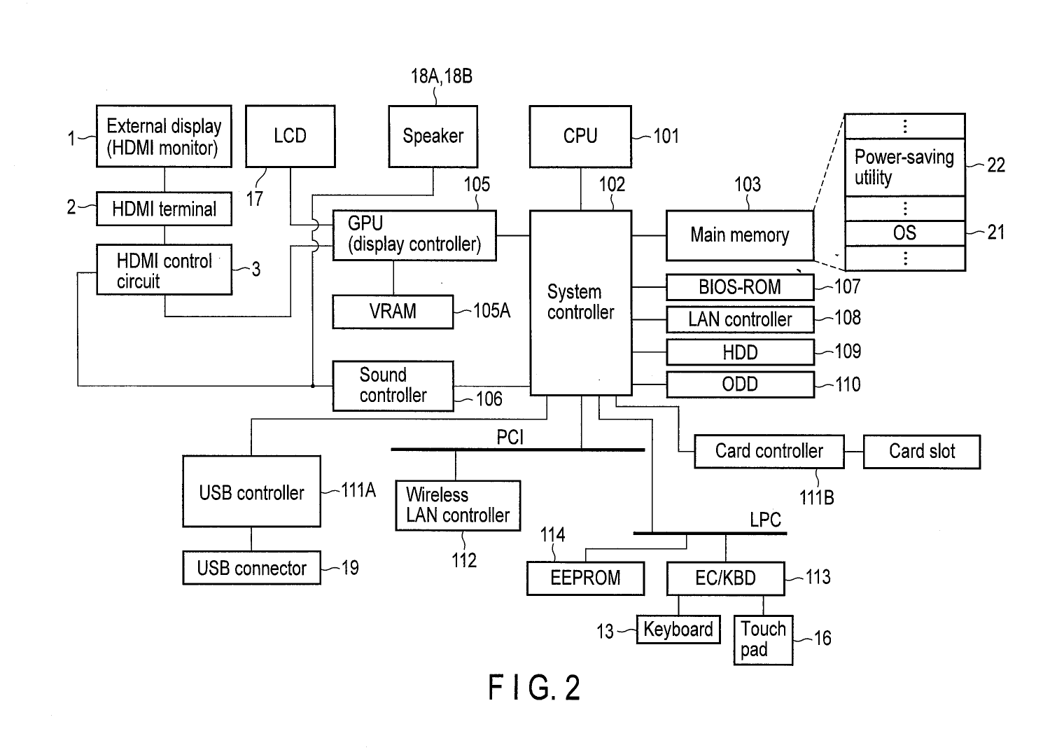

FIG. 2 is a view illustrating the system configuration of the computer 10.

The computer 10, as shown in FIG. 2, includes a CPU 101, a system controller 102, a main memory 103, a graphics processing unit (GPU) 105, a video RAM (VRAM) 105A, a sound controller 106, a BIOS-ROM 107, a LAN controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an EEPROM 114.

The CPU 101 is a processor configured to control the operations of the respective components in the computer 10. The CPU 101 executes an operating system (OS) 21, various utility programs and various application programs, which are loaded from the HDD 109 into the main memory 103. The utility programs include a power-saving utility program 22.

The power-saving utility program 22 is a program for setting values of respective power-saving setup items in power-saving setup information in accordance with a user operation, and operating the computer 10 in a power-saving mode (eco mode). The power-saving setup information includes, as the above-described power-saving setup items, a plurality of setup items relating to the operation of the computer 10, which affects the amount of power consumed by the computer 10.

In the present embodiment, a flexible power-saving mode (eco mode) which includes a plurality of power-saving levels (eco levels) is used. The plural power-saving levels include, for example, nine levels of level 2 to level 10. Level 10 is a maximum power-saving level with a highest power-saving effect of the plural power-saving levels. When the computer 10 has been set at level 10, that is, the maximum power-saving level, each of the values of the plural power-saving setup items is set at a minimum value in the range which is usable in the power-saving mode. The range which is usable in the power-saving mode is specified in advance with respect to each of the power-saving setup items. Level 2 is a minimum power-saving level with a lowest power-saving effect of the plural power-saving levels. When the computer 10 has been set at level 2, that is, the minimum power-saving level, each of the values of the plural power-saving setup items is set at a maximum value in the range which is usable in the power-saving mode. Level 7 is a reference power-saving level with a power-saving effect between the maximum power-saving level and the maximum power-saving level. When the computer 10 has been set at level 7, that is, the reference power-saving level, each of the values of the plural power-saving setup items is set at a reference value (initial setup value) in the range which is usable in the power-saving mode.

Besides, the CPU 101 executes a BIOS which is stored in the BIOS-ROM 107. The BIOS is a program for hardware control.

The system controller 102 is a bridge device which connects a local bus of the CPU 101 and the respective components. The system controller 102 includes a memory controller which access-controls the main memory 103. The system controller 102 also has a function of communicating with the GPU 105 via, e.g. a PCI EXPRESS serial bus.

The GPU 105 is a display controller which controls the LCD 17 that is used as a display monitor of the computer 10. A display signal, which is generated by the GPU 105, is sent to the LCD 17. In addition, the GPU 105 can send a digital video signal to an external display 1 via an HDMI control circuit 3 and an HDMI terminal 2.

The HDMI terminal 2 is the above-described external display connection terminal. The HDMI terminal 2 is capable of sending a non-compressed digital video signal and a digital audio signal to the external display 1, such as a TV, via a single cable. The HDMI control circuit 3 is an interface for sending a digital video signal to the external display 1, which is called “HDMI monitor”, via the HDMI terminal 2.

The system controller 102 controls devices on a PCI (Peripheral Component Interconnect) bus and devices on an LPC (Low Pin Count) bus. The system controller 102 includes an IDE (Integrated Drive Electronics) controller for controlling the HDD 109 and ODD 110. The system controller 102 also has a function of communicating with the sound controller 106.

The sound controller 106 is a sound source device and outputs audio data, which is a playback target, to the speakers 18A and 18B or the HDMI control circuit 3. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11 standard. The USB controller 111A communicates with an external device which is connected via the USB connector 19. The card controller 111B executes data write and data read in/from a memory card which is inserted in a card slot provided in the computer main body 11.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

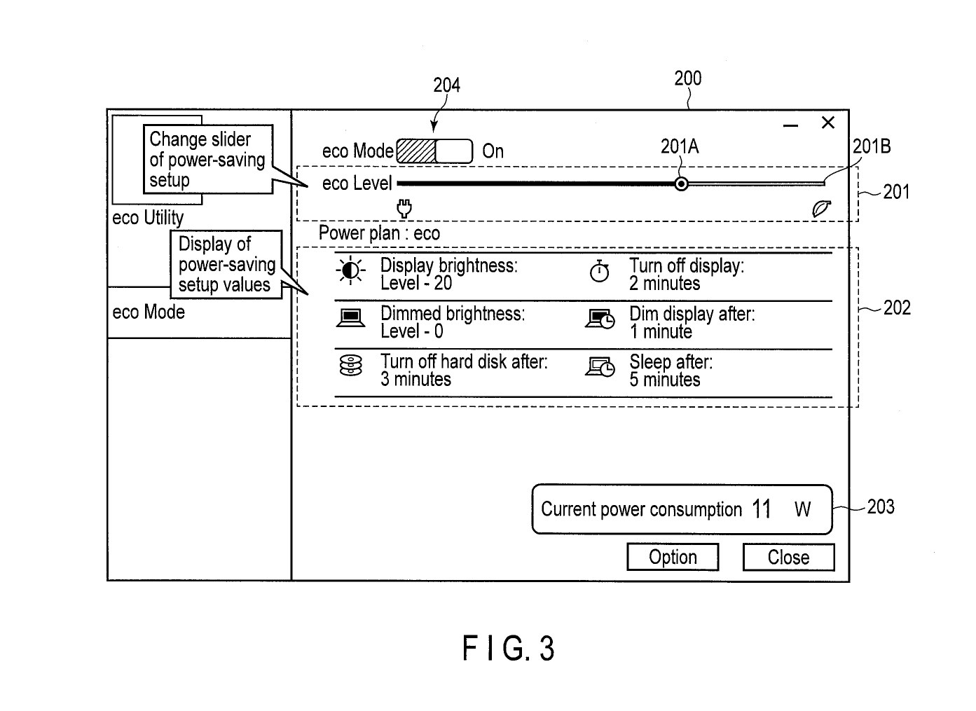

FIG. 3 illustrates an example of a power-saving setup screen 200 which is displayed on the LCD 17 by the power-saving utility program 22. The power-saving setup screen 200 is a GUI for enabling the user to easily set up or change the power-saving mode (eco mode). Using the power-saving setup screen 200, the user can easily set values of the respective power-saving setup items.

To begin with, a description is given of some examples of the power-saving setup items, which are supported by the power-saving utility program 22. The respective power-saving setup items are used for setting up the operational environment of the computer 10, which affects the amount of power consumed by the computer 10. The power-saving setup items include, for instance, the following setup items.

The brightness of the screen (display brightness): This power-saving setup item is used for controlling the brightness of the display screen. The range of adjustment of the brightness (luminance) of the display screen is, for example, from level 1 (darkest) to level 100 (brightest). Level 1 is indicative of a brightness of 1% of the maximum brightness, and level 100 is indicative of a brightness of 100% of the maximum brightness. In the power-saving mode (eco mode), the usable range of brightness of the screen is limited to a range from the minimum value (level 5) to the maximum value (level 37).

The time until turn-off of the display (turn off display after): This power-saving setup item is used for executing control to turn off power of the display at an idle time. In this setup item, a time period from when the system is set in the idle state to when the power of the display is turned off is set. The adjustment range of this time period is, for example, from one minute (shortest) to nine minutes (longest). In the power-saving mode (eco mode), the usable range of the time period is limited to a range from the minimum value (one minute) to the maximum value (four minutes).

The time until dimming of the screen (dim display after): This power-saving setup item is used for executing control to dim (darken) the display at an idle time. In this setup item, a time period from when the system is set in the idle state to when the display is dimmed is set. The adjustment range of this time period is, for example, from one minute (shortest) to four minutes (longest). In the power-saving mode (eco mode), the usable range of the time period is limited to one minute.

The brightness of the screen at a time of dimming (dimmed display brightness): This power-saving setup item is used for controlling the brightness of the display screen at a time of dimming of the screen. The adjustment range of brightness of the screen at a time of dimming is, for example, from level 1 (darkest) to level 10 (brightest). In the power-saving mode (eco mode), the usable range of the brightness of the display screen at a time of dimming is limited to a range from the minimum value (level 1) to the maximum value (level 8).

The time until turn-off of the HDD (turn off hard disk after): This power-saving setup item is used for executing control to turn off power of the HDD at an idle time. In this setup item, a time period from when the system is set in the idle state to when the power to the HDD is turned off is set. The adjustment range of this time period is, for example, from one minute (shortest) to 19 minutes (longest). In the power-saving mode (eco mode), the usable range of the time period is limited to a range from one minute (minimum value) to eight minutes (maximum value).

The time until sleep (sleep after): This power-saving setup item is used for executing control to transition the system to a sleep state (standby state) at an idle time. In this setup item, a time period from when the system is set in the idle state to when the system is transitioned to the sleep state is set. The adjustment range of this time period is, for example, from one minute (shortest) to 15 minutes (longest). In the power-saving mode (eco mode), the usable range of the time period is limited to a range from one minute (minimum value) to 13 minutes (maximum value).

The power-saving setup screen 200 includes a slider display area 201, a power-saving setup display area 202, a power consumption display area 203 and an indicator 204. The slider display area 201 is a first interface for displaying a slider 201A which is movable along a slider bar 201B that is a horizontally extending path. The slider 201A is used as a control object (graphical user interface) for changing the present power-saving setup in accordance with the moving operation of the slider 201A by the user. For example, the user drags the slider 201A to the right or the left in the state in which the slider 201A is being selected with use of the pointing device, and thereby the user can move the slider 201A to an arbitrary position on the slider bar 201B.

The power-saving utility program 22 simultaneously sets the values of plural power-saving setup items so that the computer 10 may operate in a power-saving mode of one of plural power-saving levels, in accordance with the position of the slider 201A on the slider bar 201B. Ten positions corresponding to ten levels, which include OFF (level 1) and nine power-saving levels (level 2 to level 10), are allocated to the slider bar 201B. The left end portion of the slider bar 201B is a position corresponding to OFF, and the right end portion of the slider bar 201B is a position corresponding to level 10. When the slider 201A is positioned at the left end portion of the slider bar 201B, setup with a greater power consumption than in minimum power-saving level 2 can be applied to each power-saving setup item (power-saving mode=OFF). When the slider 201A has been moved from the left end portion of the slider bar 201B toward the right end portion of the slider bar 201B, the power-saving utility program 22 displays, as shown in FIG. 3, the indicator 204 in a display fashion for indicating enabling (ON) of the power-saving mode (eco mode). Then, the power-saving utility program 22 selects one of the power-saving levels (level 2 to level 10) in accordance with a position at the destination of movement of the slider 201A, and sets batchwise the values of plural power-saving setup items to be values corresponding to the selected power-saving level, based on setup value information (to be described later) which is indicative of the relationship between the respective power-saving levels and the values of the respective power-saving setup items.

Besides, the indicator 204 may be used as a button for setting the computer 10 in the power-saving mode (eco mode). If the indicator 204 is selected by the operation of the pointing device by the user, the computer 10 is set in the power-saving mode (eco mode). In this case, each power-saving setup item may be set at the value corresponding to the above-described reference power-saving level.

The power-saving setup display area 202 displays the above-described plural power-saving setup items and the present values of these power-saving setup items. When the computer 10 has been set in the power-saving mode (eco mode) of a certain power-saving level by the power-saving utility program 22, the value of each power-saving setup item, which corresponds to this power-saving level, is displayed in the power-saving setup display area 202. The power consumption display area 203 displays the present power consumption of the computer 10.

In addition, the power-saving utility program 22 can update in real time the values of the respective power-saving setup items on the power-saving setup display area 202 in accordance with the movement of the slider 201A. For example, while the slider 201A is being dragged (during the moving operation), the power-saving utility program 22 may update in real time the values of the respective power-saving setup items on the power-saving setup display area 202, and when the selection of the slider 201A has been released, the power-saving utility program 22 may set/change the values of the respective power-saving setup items in accordance with the present position of the slider 201A. Thereby, the user can execute the operation of moving the slider 201A, while viewing the values of the respective power-saving setup items.

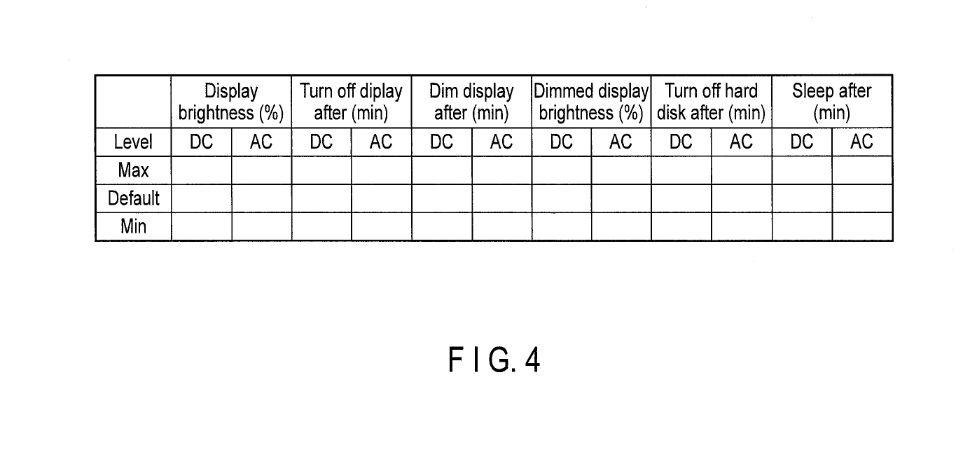

FIG. 4 illustrates the relationship between power-saving levels and respective power-saving setup values. In the present embodiment, the relationship between power-saving levels and respective power-saving setup values is predetermined in consideration of the above-described three power-saving levels, namely the minimum power-saving level (Min), maximum power-saving level (Max) and reference power-saving level (Default). Specifically, to begin with, three values corresponding to these three power-saving levels are specified for each of the power-saving setup items. Then, values of each power-saving setup item corresponding to power-saving levels other than these three power-saving levels are interpolated by using a polynomial expression (polynomial approximation curve) passing through these three values with respect to each of the power-saving setup items.

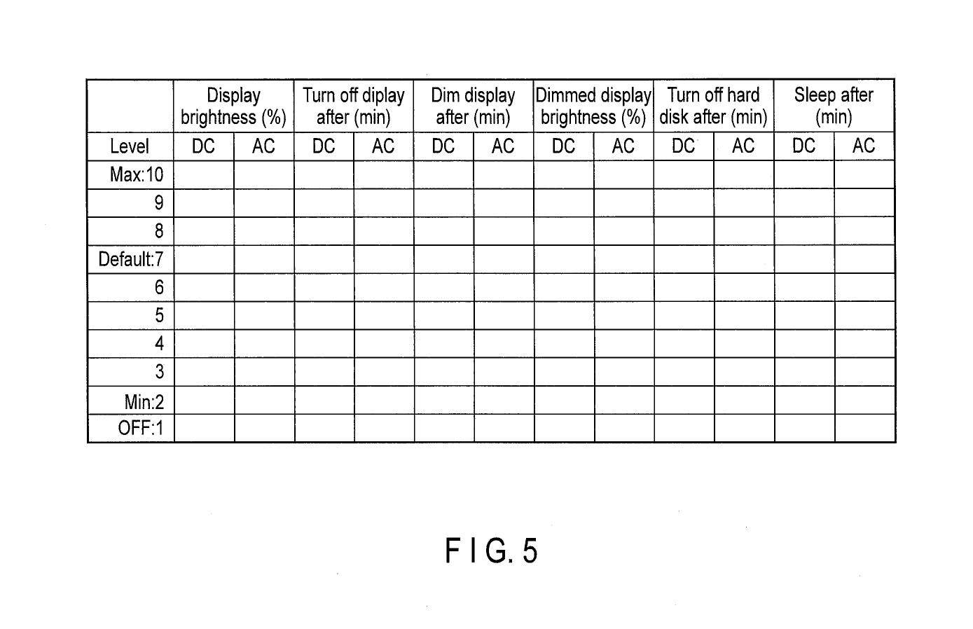

FIG. 5 illustrates the relationship between power-saving levels corresponding to power-saving levels 2 to 10 and the power-saving setup values corresponding to these power-saving levels. With respect to each power-saving setup item, “DC” is indicative of a value which is to be used when the computer 10 is being driven by the battery in the computer 10, and “AC” is indicative of a value which is to be used when the computer 10 is being driven by external power which is supplied via, e.g. an AC adapter.

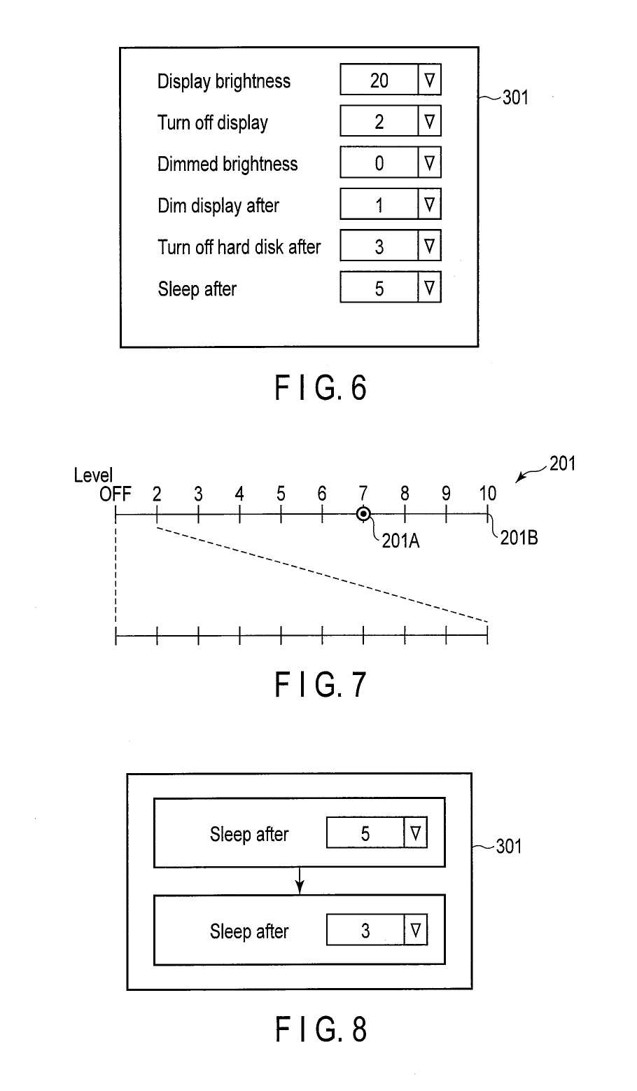

FIG. 6 illustrates an example of a power-saving setup screen 301 which is displayed by a tool for individually setting/changing the values of the above-described plural power-saving setup items. This tool is a second interface which is different from the above-described first interface including the slider 201A. This tool, that is, the second interface, may be realized by a utility program such as a power option in the OS 21. The above-described power-saving setup information, which is indicative of present values of the respective power-saving setup items, is stored in a memory area such as a registry, and can be shared by the power-saving utility program 22 and the above-described tool. Thus, each of the power-saving utility program 22 and the tool can acquire the present values of the power-saving setup items. In addition, after setting batchwise the values of plural power-saving setup items by executing the operation of moving the slider 201A on the power-saving setup screen 200 of FIG. 3, the user can individually change the value of at least one arbitrary power-saving setup item on the power-saving setup screen 301 which is displayed by the above-described tool. In this case, it is possible that the position of the slider 201A on the power-saving setup screen 200 of FIG. 3 no longer agrees with the position corresponding to the present power-saving setup values.

In the present embodiment, the power-saving utility program 22 further includes a function of correcting (changing) the position of the slider 201A. Specifically, if the value of at least one power-saving setup item of the above-described plural power-saving setup items has been changed by the tool (second interface), the power-saving utility program 22 automatically corrects (changes) the position of the slider 201A on the slider bar 201B, based on the changed value of the at least one power-saving setup item. Thereby, since the slider 201A can be brought close to the correct position which corresponds to each actual power-saving setup value, the user can correctly be notified of the contents of the present power-saving setup.

In the meantime, the above-described tool is not necessarily required to be able to set/change all the above-described plural power-saving setup items, and it should suffice if the tool can set/change at least one power-saving setup item. In addition, as the above-described second interface, use may be made of an interface which increases or decreases the value of at least one power-saving setup item, such as the brightness of the screen or the brightness of the screen at a time of dimming, in accordance with pressing of at least one specific function key on the keyboard.

FIG. 7 illustrates intervals of movement of the slider 201A. Ten levels of “OFF”, power-saving level 2, power-saving level 3, . . . , power-saving level 10 are allocated to the slider bar 201B from the left end portion to right end portion of the slider bar 201B. The position of the slider 201A, which can be moved by the user operation, is a position corresponding to any one of the ten levels. On the other hand, actually, many power-saving sub-levels, which are more than ten, for example, 100 power-saving sub-levels (100 sub-positions), are allocated to the slider bar 201B, and the slider 201A can move to any one of the 100 sub-positions on the slider bar 201B. Thereby, in the above-described process of automatically correcting (changing) the position of the slider 201A on the slider bar 201B, since the power-saving utility program 22 can move the slider 201A to any one of the 100 sub-positions, the power-saving utility program 22 can precisely correct (change) the position of the slider 201A.

Next, the operation of correcting (changing) the position of the slider 201A is described.

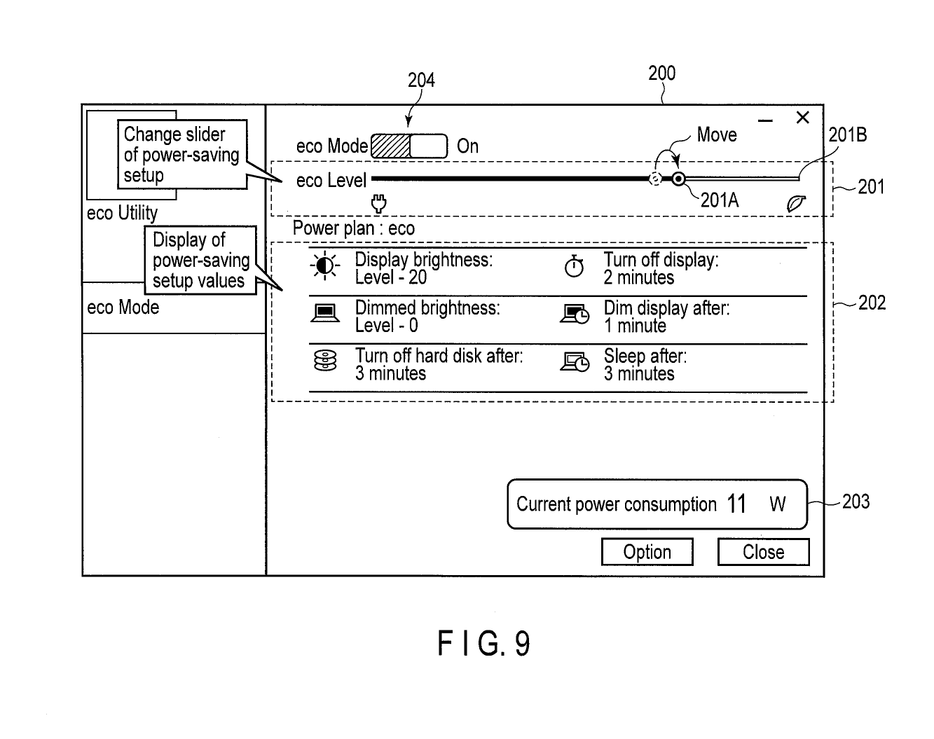

FIG. 8 illustrates a state in which the user changes the “time until sleep” (sleep after) on the power-saving setup screen 301 from 5 minutes to 3 minutes. The “sleep after=5 minutes” is a value which was set in accordance with the moving operation of the slider 201A on the power-saving setup screen 200. In this manner, when the value of a certain power-saving setup item has been individually changed after plural power-saving setup items were batchwise set up in accordance with the moving operation of the slider 201A, the power-saving utility program 22, as shown in FIG. 9, moves the present position of the slider 201A, which is displayed on the power-saving setup screen 200, toward the right end portion of the slider bar 201B, and corrects (changes) the present position of the slider 201A, based on the time (3 minutes) after the change.

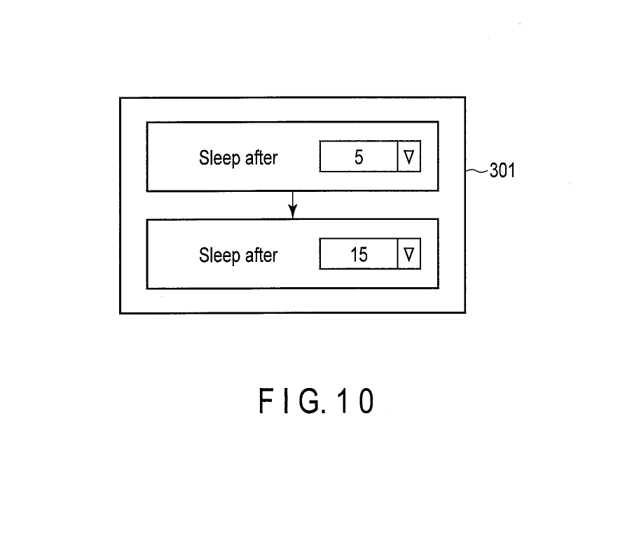

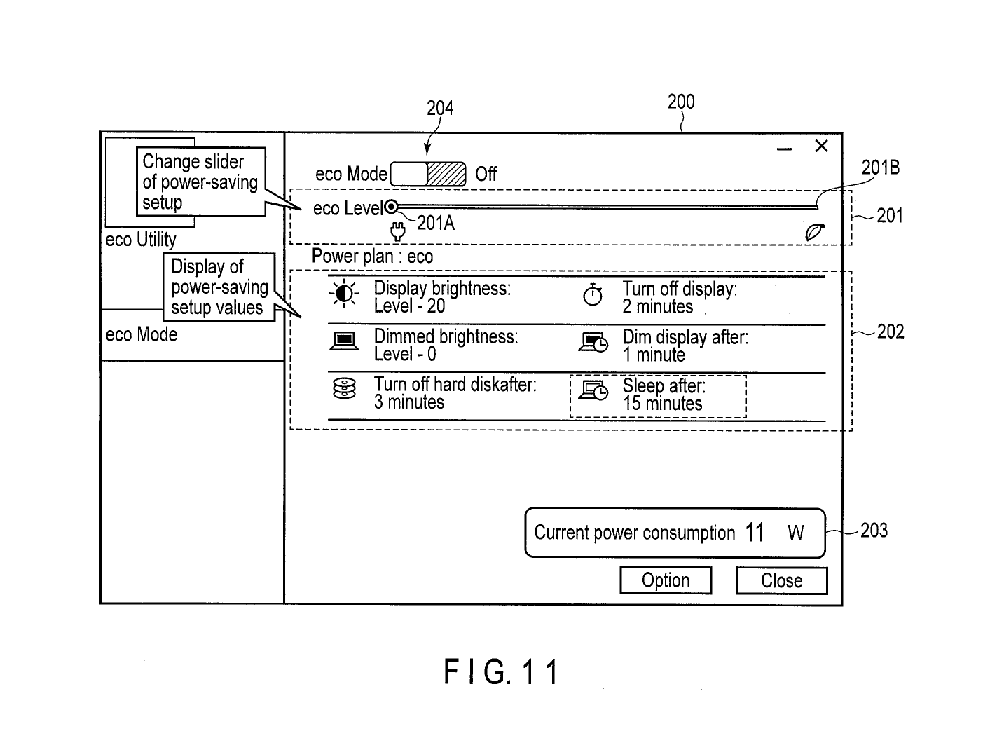

FIG. 10 illustrates a state in which the user changes the “time until sleep” (sleep after) on the power-saving setup screen 301 from 5 minutes to 15 minutes. The “sleep after =5 minutes” is a value which was set in accordance with the moving operation of the slider 201A on the power-saving setup screen 200. In this manner, when the value of a certain power-saving setup item has been individually changed after plural power-saving setup items were batchwise set up in accordance with the moving operation of the slider 201A, the power-saving utility program 22, as shown in FIG. 11, corrects (changes) the present position of the slider 201A which is displayed on the power-saving setup screen 200, based on the time (15 minutes) after the change. In the present embodiment, the maximum value of the “time until sleep” (sleep after), which is usable in the power-saving mode, is 14 minutes. The time (15 minutes) after the change is greater than the maximum value (14 minutes) of the “time until sleep” (sleep after), which is usable in the power-saving mode. Thus, the power-saving utility program 22 moves the present position of the slider 201A to the left end portion of the slider bar 201B.

Further, the power-saving utility program 22 displays the “time until sleep” (sleep after) and the present setup value (15 minutes) thereof in a display fashion different from the display fashion of the other power-saving setup items and the present values thereof. For example, the “time until sleep” (sleep after) and the present setup value (15 minutes) thereof may be grayed out, or the “time until sleep” (sleep after) and the present setup value (15 minutes) thereof may be surrounded by a frame and displayed. Thereby, a power-saving setup item which is a cause of disabling of the power-saving mode, that is, a power-saving setup item which was changed to a value falling out of the range that is usable in the power-saving mode, can be presented easily understandably to the user.

Moreover, the power-saving utility program 22 changes the display fashion of the indicator 204 to a display fashion indicating disabling (OFF) of the power-saving mode. Thereby, it can be easily understandably presented to the user that the present power-saving setup is out of the range of the power-saving mode (eco mode), that is, the power-saving mode is disabled (OFF).

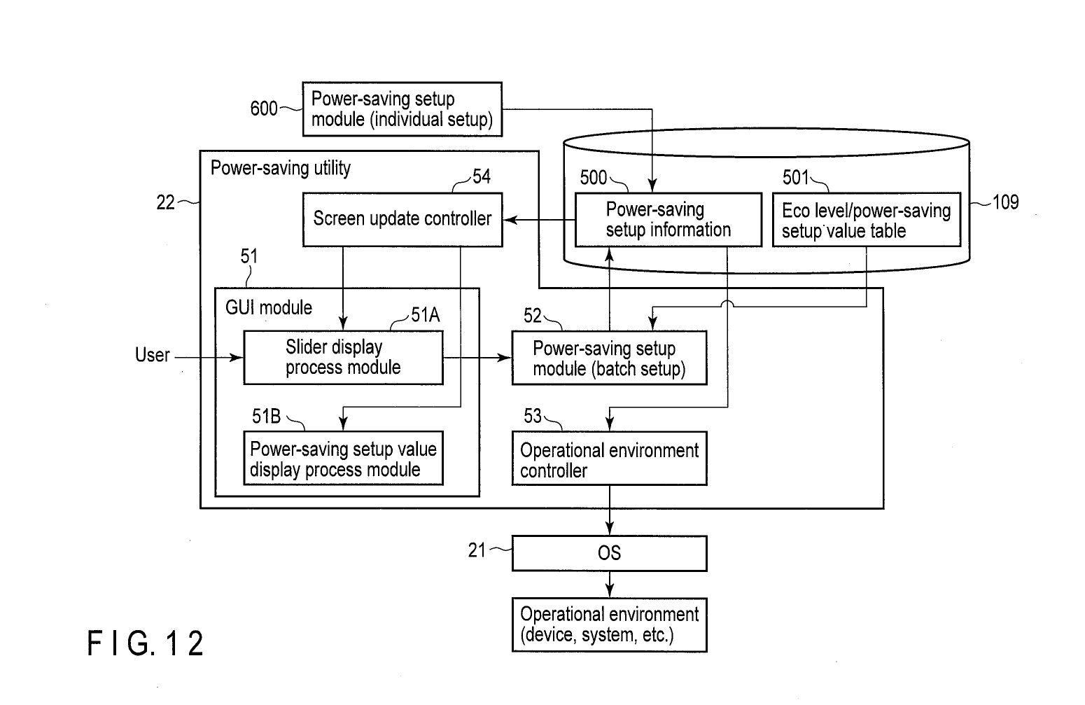

FIG. 12 illustrates the configuration of the power-saving utility program 22.

The power-saving utility program 22 includes, as function execution modules, a user interface (GUI) module 51, a power-saving setup module 52, an operational environment controller 53, and a screen update controller 54.

The user interface (GUI) module 51 functions as a display processor configured to display the power-saving setup screen 200 which has been described with reference to FIG. 3. The user interface (GUI) module 51 includes a slider display process module 51A and a power-saving setup value display process module 51B. The slider display process module 51A displays the slider 201A, which is movable along the slider bar 201B, on the power-saving setup screen 200. The power-saving setup value display process module 51B displays on the power-saving setup screen 200 a plurality of power-saving setup items and present values of these plural power-saving setup items.

The power-saving setup module 52 selects one of the above-described plural power-saving levels in accordance with the position of the slider 201A on the slider bar 201B, the slider 201A being moved in accordance with a user operation. Then, the power-saving setup module 52 simultaneously sets the values of the respective power-saving setup items in power-saving setup information 500, which is stored in the HDD 109, to be values corresponding to the selected power-saving level, so that the computer 10 may operate in a power-saving mode of the selected power-saving level. The values of the respective power-saving setup items, which correspond to the selected power-saving level, are prestored as setup value information in an eco level/power-saving setup value table 501. This setup value information is information indicative of values of the respective power-saving setup items with respect to each power-saving level (eco level).

For example, if the slider 201A is moved to a first position near the left end portion of the slider bar 201B, the power-saving setup module 52 selects the minimum power-saving level (power-saving level 2), and sets the values of the plural power-saving setup items to be maximum values in the range which is usable in the power-saving mode. If the slider 201A is moved to a second position near the right end portion of the slider bar 201B, the power-saving setup module 52 selects the maximum power-saving level (power-saving level 10), and sets the values of the plural power-saving setup items to be minimum values in the range which is usable in the power-saving mode. As described above, the reference power-saving level (power-saving level 7) is allocated to a predetermined position (third position) between the first position and the second position of the slider bar 201B. If the slider 201A is moved to the predetermined position (third position), the power-saving setup module 52 sets the values of the plural power-saving setup items to be reference values in the range which is usable in the power-saving mode.

The power-saving setup information 500 is information indicative of power-saving setup values corresponding to the plural power-saving setup items, as described with reference to FIG. 3. The operational environment controller 53 controls the operation of the computer 10, that is, the operation (operational environment) of each device and system in the computer 10, based on the values (power-saving setup values) of the respective power-saving setup items in the power-saving setup information 500. The control of the operation (operational environment) of each device and system in the computer 10 is executed via the OS 201.

A power-saving setup module 600 is the above-described tool for individually setting/changing the values of the respective power-saving setup items. In accordance with a user operation, the power-saving setup module 600 can individually set/change the values of the respective power-saving setup items in the power-saving setup information 500.

The screen update controller 54 functions as one portion of the display processor. The screen update controller 54 executes, in cooperation with the user interface (GUI) module 51 which functions as the display processor, various processes for updating the content of the power-saving setup screen 200, including correction of the slider position.

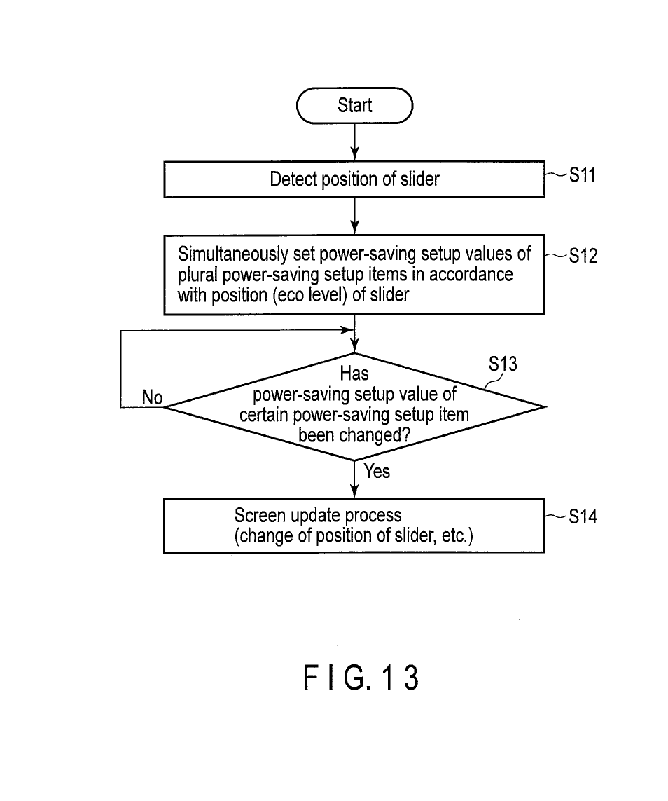

A flowchart of FIG. 13 illustrates the procedure of a power-saving setup process which is executed by the power-saving utility program 22.

If the slider 201A is moved by a user operation, the power-saving utility program 22 detects the position on the slider bar 201B, to which the slider 201A has been moved (step S11). Then, the power-saving utility program 22 simultaneously sets the values (power-saving setup values) of the plural power-saving setup items in the power-saving setup information 500 in accordance with the present position of the slider 201A, that is, in accordance with the power-saving level (eco level) corresponding to the present position of the slider 201A (step S12). Thereby, the computer 10 is controlled to operate in the power-saving mode of the power-saving level corresponding to the present position of the slider 201A.

If the value of at least one arbitrary power-saving setup item is changed (YES in step S13), the power-saving utility program 22 updates the content of the power-saving setup screen 200 so that the content of the changed power-saving setup may reflect on the power-saving setup screen 200 (step S14). In step S14, as described above, the process of correcting (changing) the position of the slider 201A, for example, is executed. In this case, based on the value of the power-saving setup item after the change, the power-saving utility program 22 corrects (changes) the position of the slider 201A on the slider bar 201B. In the process of correcting (changing) the position of the slider 201A, the power-saving utility program 22 may acquire the power-saving setup information 500, determine which of the above-described power-saving sub-levels the present power-saving setup indicated by the acquired power-saving setup information 500 corresponds to, and move the slider 201A to the position on the slider bar 201B, which corresponds to the determined power-saving sub-level.

As has been described above, according to the present embodiment, the first interface including the slider 201A, which is movable along the path, is displayed on the screen, and the values of the plural power-saving setup items are set so that the computer 10 may operate in the power-saving mode of one of the plural power-saving levels, in accordance with the position of the slider 201A. Accordingly, the power-saving function of the computer 10 can easily be set up, and the computer 10 can be set in the power-saving mode of a desired power-saving level. In addition, if the value of at least one of the plural power-saving setup items has been changed by the second interface, the position of the slider 201A is changed based on the changed value. Thus, since the slider 201A can be brought close to a position corresponding to each actual power-saving setup value, the user can correctly be notified of the contents of the present power-saving setup.

All the procedures of the power-saving setup process of the embodiment can be executed by software. Thus, the same advantageous effects as with the present embodiment can easily be obtained simply by installing a computer program, which executes these procedures, into an ordinary computer through a computer-readable storage medium which stores the computer program, and executing the computer program. In addition, the functions of the respective components shown in FIG. 12 may be realized by hardware such as a purpose-specific LSI or a DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display processor configured to display on a screen a first interface comprising a slider configured to be movable along a path, wherein the positions along the slider corresponds to power-saving levels of a power-saving mode; and
a power-saving setup module configured to set values of a plurality of power-saving setup items in accordance with a first power-saving level of a plurality of power-saving levels for the information processing apparatus based upon a first position along the slider,
wherein the display processor is further configured to change, when a value of at least one power-saving item of the plurality of power-saving setup items is changed by a second interface which is different from the first interface, the first position of the slider on the path based on the changed value of the at least one power-saving setup item.

2. The information processing apparatus of claim 1, wherein the display processor is further configured to display on the screen the plurality of power-saving setup items and present values of the plurality of power-saving setup items, and display, when the changed value of the at least one power-saving setup item is greater than a maximum value in a range which is usable in the power-saving mode, the at least one power-saving setup item and the value of the at least one power-saving setup item in a display fashion different from a display fashion of the other power-saving setup items and values of the other power-saving setup items.

3. The information processing apparatus of claim 1, wherein the display processor is configured to display, when the slider is moved from a first end portion of the path toward a second end portion of the path, an indicator on the screen in a first display fashion for indicating enabling of the power-saving mode, and to change, when the changed value of the at least one power-saving setup item is greater than a maximum value in a range which is usable in the power-saving mode, the indicator from the first display fashion to a second display fashion for indicating disabling of the power-saving mode.

4. The information processing apparatus of claim 3, wherein the display processor is further configured to move, when the changed value of the at least one power-saving setup item is greater than the maximum value in the range which is usable in the power-saving mode, the slider to the first end portion of the path.

5. The information processing apparatus of claim 1, wherein the power-saving setup module is further configured to set the values of the plurality of power-saving setup items to be maximum values in a range which is usable in the power-saving mode when the slider is moved to a first position near a first end portion of the path, to set the values of the plurality of power-saving setup items to be minimum values in the range when the slider is moved to a second position near a second end portion of the path, and to set the values of the plurality of power-saving setup items to be reference values in the range when the slider is moved to a third position between the first position and the second position.

6. The information processing apparatus of claim 1, wherein the power-saving setup module is further configured to select one of the plurality of power-saving levels in accordance with the position of the slider on the path, and to set the values of the plurality of power-saving setup items to be values corresponding to the selected power-saving level, based on setup value information indicative of a relationship between the respective power-saving levels and the values of the respective power-saving setup items.

7. The information processing apparatus of claim 1, wherein the plurality of power-saving levels comprise at least (i) a minimum power-saving level at which a power-saving effect is configured to be lowest of the plurality of power-saving levels and the values of the plurality of power-saving setup items are configured to be maximum values in a range which is usable in the power-saving mode, (ii) a maximum power-saving level at which the power-saving effect is configured to be highest of the plurality of power-saving levels and the values of the plurality of power-saving setup items are configured to be minimum values in the range, and (iii) a reference power-saving level at which the power-saving effect is configured to be between the minimum power-saving level and the maximum power-saving level and the values of the plurality of power-saving setup items are configured to be reference values in the range.

8. An operation control method of an information processing apparatus, comprising:
displaying on a screen a first interface comprising a slider configured to be movable along a path;
setting values of a plurality of power-saving setup items in accordance with a position of the slider on the path, such that the information processing apparatus operates in one of a plurality of power-saving levels of a power-saving mode; and
changing, when a value of at least one power-saving item of the plurality of power-saving setup items is changed by a second interface which is different from the first interface, the position of the slider on the path based on the changed value of the at least one power-saving setup item.

9. A computer-readable, non-transitory storage medium comprising a program configured to be executed by a computer, the program controlling the computer to execute functions of:
displaying on a screen a first interface comprising a slider which is movable along a path;
setting values of a plurality of power-saving setup items in accordance with a position of the slider on the path, such that the computer operates in one of a plurality of power-saving levels of a power-saving mode; and
changing, when a value of at least one power-saving item of the plurality of power-saving setup items is changed by a second interface which is different from the first interface, the position of the slider on the path based on the changed value of the at least one power-saving setup item.
